(19) United States
(12) Patent Application Publication
(10) Pub. No.: US 2009/0006551 A1
(43) Pub. Date: Jan. 1, 2009

(54) DYNAMIC AWARENESS OF PEOPLE

(75) Inventors: Shai Guday, Redmond, WA (US); Nigel Stuart Keam, Redmond, WA (US); Steven N. Bathiche, Kirkland, WA (US); James Morris Alkove, Woodinville, WA (US); Zachary L. Russell, Bellevue, WA (US); Jon Marcus Randall Whitten, Sammamish, WA (US); Boyd C. Multerer, Redmond, WA (US); Andrew David Wilson, Seattle, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/771,388

(22) Filed: Jun. 29, 2007

(51) Int. Cl. G06F 15/16

(52) U.S. Cl. 709/204

(57) ABSTRACT

A system for sharing collective information is provided. The system includes a profile component that receives information regarding a user's profile. A detection component determines profiles of other users related to the user's profile and a content component relays data associated with the other users in view of the user's profile.

### BACKGROUND

People often experience situations as individuals yet have no knowledge of collective or group experiences that may have come before them. Thus, unless a person knows of someone who can share a particular experience, people are often left to themselves to rediscover things completely on their own. Unfortunately, the richness of other similarly situated people is lost on those encountering situations for the first time.

Before the Internet, people most likely learned of the day's events through newspapers or magazines. This type of information was often static and sometimes there was a serious time lag before one user's experience could be shared with another. In a magazine scenario, one writer may have shared a real life experience that may benefit many people yet the dissemination of that to others may have taken weeks, months, and perhaps years to filter out to those who may have found value in the respective experience. Daily newspapers certainly offer more real time information but the information generated has to reach the level of what is considered news before reaching the public. Thus, there may be many common experiences encountered over time that may not be considered newsworthy yet still have value for people if they could somehow become aware and harness the experiences. For example, the newspaper may have reported a celebrity visiting a local shopping mall and made an effort to report why the celebrity was in town and what their motivations were for coming to the location. There may have been a collection of people at the mall to welcome the celebrity yet their collective experiences may have been lost since they would not be inclined to chat with other people at the event nor would their collective ideas have made it into the newspaper. Although a news type of event may report one or two people's eye witness account of a given event, group dynamics and other rich contexts associated with a group's collective thinking are lost when one person is charged with reporting.

With the advent of the Internet, media experiences have certainly increased and changed for most people. News and information seems instantaneous and seems to be continually generated in real time. One type of media experience is the news site where a site is organized around current news event or tailored somewhat to a particular style. Most of the traditional news outlets maintain websites to augment what these outlets offer in print. Many sites offer links to current news events. Some sites have a political slant to their news offerings where the types of links they provide to current events tend to support such views. Even though much more information can be gathered over thousands of websites, information is still basically presented in a static form where users must determine they are first interested in a site and then seek information from the site which is similar to reading a newspaper in the past. This static type of information retrieval however again is void of context from other users who may be searching for information with similar questions in mind.

One type of media that has grown in recent years is the Blog where users can share their ideas and experiences by merely hosting a website. Blogs have become increasingly popular over the Internet, and are the easiest way to publish one's thoughts. Basically, a Blog (short for “Weblog”) is an interactive, personalized Web journal for posting one's views, art, rants, raves, reviews, pictures, or music that someone may want to share with many or a private group. Blog entries (“posts” or “updates”) can be made at any time—for example a “what's new” page or a journal—from news updates, to humor, insights, and so forth. Generally, the Blog includes journal-like entries organized by chronology where the latest posts are usually at the top, and older posts can be easily viewed by visitors. Even with the real time nature of Blogs to share information between users, there are still deficiencies with this type of media. For instance, before someone can receive information from a respective Blog they have to be aware of the Blog and understand what type of content they may receive there from. Also, Blog's may not be consistent with the topics that may be considered worth discussing on that particular day. Thus, if one wanted to know what the current Blog thinking on a given topic, they would have to search for the topic and the potential Blog sites that may be discussing the topic. In other words, there are no automated methods for dynamically discovering what other people may be interested in and what their perceptions may in fact be.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

Collaboration components are provided for determining like-minded people based on profiles and stored data. Such data can be shared dynamically with people who may be encountering or experiencing events for the first time. In this manner, people can communicate with others in real time while mitigating searching efforts to determine if anyone else has had similar experiences or questions. This can include sharing information between users during live events or sharing real time thoughts and rankings during gaming situations, for example. Dynamic collections can be created, updated and maintained across a segment of a population where people can generate their own brand of frame across the group. As data collections are accessed and updated over time, users can begin to discover rich information stores about people and experiences that others may have had before them.

Adaptive profiles can be maintained where data that users come in contact is continually updated for preferences and context and subsequently shared as appropriate. Voting schemes can be provided so that when one comes in contact with a given media, a platform such as a cell phone interface can be provided to presently vote and dynamically view past and present opinions on the selected media. Shared media experiences can include real time events such as watching a football game, determining something one wants to share in the group and passing that along to other media outlets such as to someone's desktop or cell phone. In another aspect, a discovery process can be linked to varying types of media. For instance, if a person were looking at an album cover, links could be provided relating to similar works of art, relating to the underlying artists, relating to the group of knowledge for the particular work when viewing the album, and/or relating to tangential links that flowed from the original viewing.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a schematic block diagram illustrating a dynamic awareness system to facilitate data exchange and collaboration between people.

FIG. 2 is a diagram that illustrates an example user profile to control dynamic information exchange.

FIG. 3 is a diagram that illustrates context pushing of data based on location and profile information.

FIG. 4 illustrates media linking components to share dynamic information.

FIG. 5 illustrates input media for storing and sharing user experience data.

FIG. 6 illustrates user based feedback for dynamically altering event outcomes.

FIG. 7 illustrates voting interfaces to facilitate exchange of user generated information.

FIG. 8 illustrates collaboration components for sharing data between members of an identified group.

FIG. 9 illustrates a methodology to present dynamic data to users based upon detected profiles.

FIG. 10 is a schematic block diagram illustrating a suitable operating environment.

FIG. 11 is a schematic block diagram of a sample-computing environment.

### DETAILED DESCRIPTION

Systems and methods are provided for dynamically sharing information across a group while mitigating efforts to find members of the group and distribute the information across the groups. In one aspect, a system for sharing collective information is provided. The system includes a profile component that receives information regarding a user's profile. A detection component determines profiles of other users related to the user's profile and a content component relays data associated with the other users in view of the user's profile. In addition to receiving information from other individuals, dynamic links or other connections can be enabled to various forms of media provide a richer user experience when encountering such media.

As used in this application, the terms “component,” “detection,” “profile,” “database,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

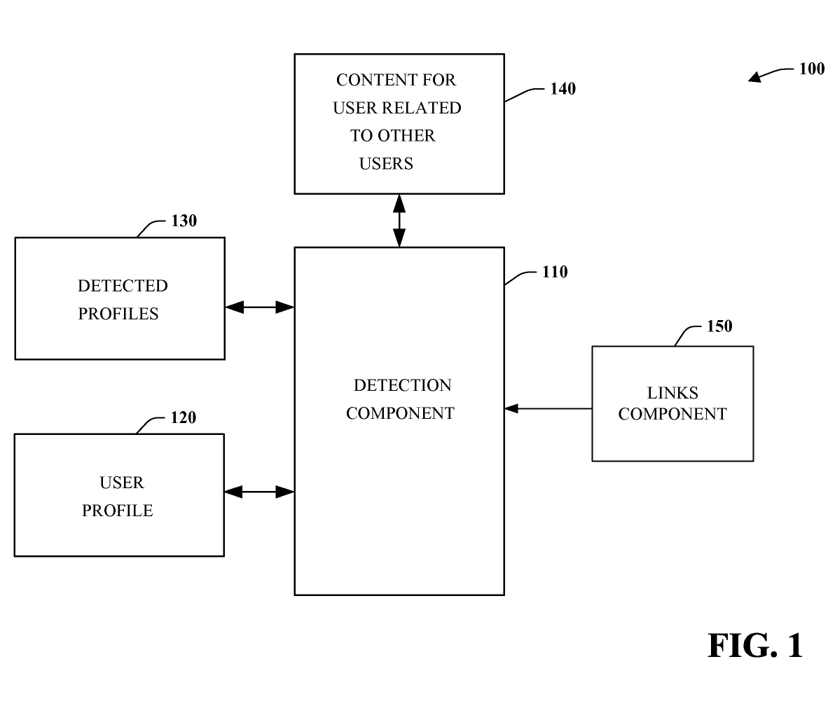

Referring initially to FIG. 1, a system 100 is illustrated to facilitate dynamic data exchange and collaboration between people. The system 100 includes a detection component 110 that maintains a user profile 120. The user profile 120 includes information about a user regarding personal preferences and interests. One or more detected profiles 130 are analyzed by the detection component 110 and in view of the user profile 120. Such analysis allows information to be freely exchanged and collaborated between similar members identified by their respective profiles 120 and 130. For example, group members attending a live concert event can exchange present thoughts in real time without having to later go searching on the Internet for potentially stale recollections that have been posted at a later time. As shown at 150, data content can be provided to the user that is related to the detected profiles 130 and their respective users. This may include real time text, audio, or video exchanges and can include such dynamic aspects as data collections or journals that are updated over time. Content at 140 can be accessed via a database (or databases not shown) that stores information related to the user profile 120 and the detected profiles 130. Such information can be stored locally in a local store and/or retrieved from remote locations such as over the Internet. The content at 140 can be exchanged via interfaces provided by mobile devices (e.g., cell phones, PDA's, portable music devices) or served locally such as from an information server. In addition to exchanging and receiving data from other members of the group via the detection component 110, one or more links may be detected at 150 which serve to provide additional information to the user at 140. For example, if a user were to approach a piece of art, the links 150 can be employed to receive additional information above and beyond that normally received by viewing the artwork.

In general, the system 100 enables building dynamic collaborations between like minded people based on profiles 120/130 and stored data and sharing such data dynamically with people who may be encountering or experiencing things for the first time. This can include inviting people to rank or evaluate a situation and making available other people's opinion of the same situation. For example, if a DJ were running a particular event, people could be encouraged to contribute an evaluation that could be shared with other members of the group who were also listening. Such dynamic evaluations could be shared over time as well. Such rankings could form the basis for dynamic data collections where individuals could potentially generate their own frame by how they appear and are populated on the collections. Similarly, teammate reviews can be provided where people could share thoughts on how a particular user ranked in a certain game or other scenario. For example, a power user may be rated as very difficult to beat where novice users may have some other indication. As time goes by and opinions are gathered, people's standing within a particular game can dynamically change. Opinions can also be gathered and shared concerning how people actually felt about playing a particular game or witnessing an event. It is also noted that dynamic collaborations and data exchanges can be facilitated for groups of users in addition to individual users. In this manner, meta relationships can be created between social network participants based upon alignment within their respective communities, for example.

In another aspect, users can associate with themselves a temporary profile such as in the case of a temporary celebrity profile. This could be relevant at a stadium, where someone attending a football game might desire to be in “John Madden” mode (or other celebrity/alias), but later revert to themselves. Similarly, one could be Norm Abrams while shopping at the home depot, or someone in a Border's bookstore donning the Oprah profile, to purchase a gift for an Oprah-phile. This also allows the user profile to be exposed beyond manual settings and the ability to mask or overlay profiles in part or in their entirety based upon time, location and purpose, for example.

In related aspects, a discovery process can be linked to varying types of media at 150. For instance, if a person were looking at an album cover, links 150 could be provided relating to similar works of art, underlying artists, the group of knowledge of the particular work when viewing the album, and tangential links that flowed from the original viewing. Adaptive profiles 120 can be maintained where data that users come in contact is continually updated on preferences and context and subsequently shared as appropriate. Voting schemes can be provided for so that when one comes in contact with a given media, a platform such as a cell phone interface can be provided to presently vote and dynamically view past and present opinions on the selected media. Shared media experiences can include real time events such as watching a football game while arriving at something one wants to share in the group and passing that along to other media outlets such as to someone's desktop or cell phone.

Player attention models can also be dynamically determined from present and past experiences and employed to dynamically adjust present user experiences. Public announcement forums can be provided where an employee for example could make an announcement and that would be shared with a group identified by the profile 120. Along with player attention models, crowds and groups can be modeled from the collective and personal data stores. Collaborative mechanisms can be provided where such aspects as sharing schedules or collections can be dynamically collected and distributed across similarly situated users defined by the profiles 120 and 130. Other dynamic aspects creating family media channels based on familial associations and content. This could include creating a short term network to share family vacation pictures or other media, for example. In another aspect, the system 100 provides a user based information system to exchange data. This includes means for identifying a user's preferences and state (user profile 120) and means for analyzing the profile (detection component 110) in view of other detected profiles 130 to facilitate dynamic data exchange between users.

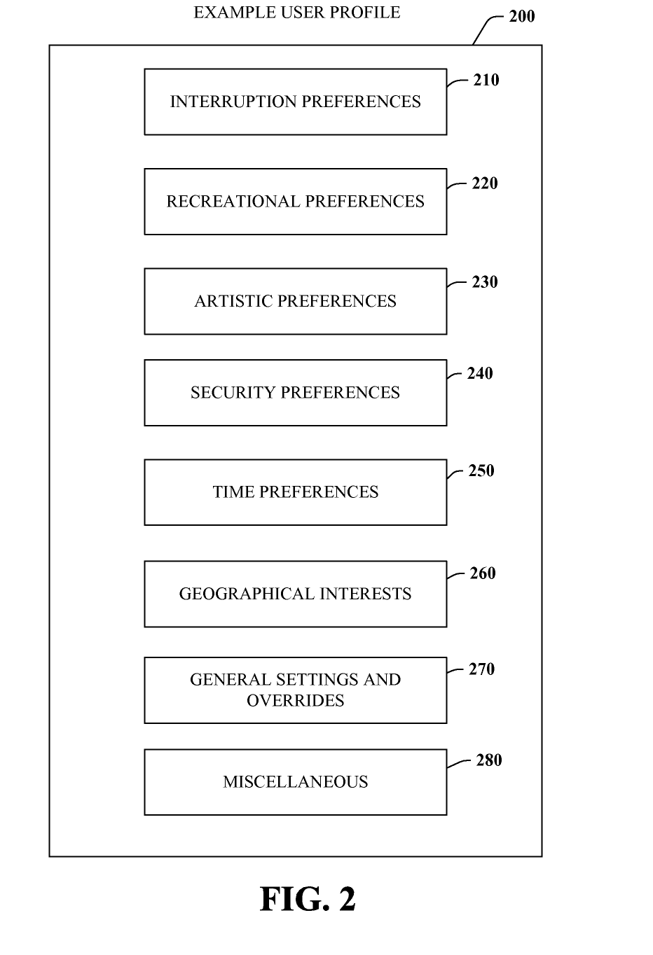

Referring now to FIG. 2, an example user profile 200 is illustrated to control dynamic information exchange. In general, the profile 200 allows users to control the types and frequency at which information may be provided to them. Some users may prefer to receive all information associated with a selected group of people whereas others may desire information under more controlled or narrow circumstances. The profile 200 allows users to select and/or define options or preferences for receiving data. At 210, interruption preferences can be defined or selected. For example, restrictions can be placed on the times when data can be sent to a user's device. Such examples include only sending data during lunch hour, or restricting the data until the user has indicated they are on vacation. This could also include tailoring signals to indicate the presence of data but not giving a full data display or output. For example, the user may see a flashing icon or hear a beep indicating the presence of data and they could select further controls to see or experience the full data output at a given location.

Proceeding to 220, the user may indicate recreational preferences. For instance, the user may indicate that they jog at certain times of day and do not desire to receive data at those times. In another context, the user may indicate they are sports enthusiasts and desire to hear location information relating to sports but perhaps not other location data. As can be appreciated, recreational constraints can be placed over a plurality of differing circumstances. At 230, artistic preferences may be defined. This may include indicating movie, musical, or other artistic genres a user may be interested in such that when a user is in the presence of a group of like-minded individuals related to those particular interests (group identified by profile), information can be presented at that time. Other aspects could include having security preferences, limitations or settings at 240 such that when a user is in a given setting, some/more information may be exchanged with others. This can include privacy settings to control how much is revealed with respect to a given user or group.

Proceeding to 250, time preferences can be entered. This can include absolute time information such as only provide information updates on weekends, or do not show information during lunch hour, or other time indication. Ranges can be specified such as please provide location information between 2:00 and 4:00 each afternoon. This can also include calendar information and other data that can be associated with time or dates in some manner. At 260, geographical interests can be indicated to tailor how location information is presented to the user. For instance, some users may not want to be bothered while at work in the city yet prefer their data in specified social settings such as when encountering other individuals at a night club or restaurant. Databases and interfaces can be provided to allow a plurality of differing designations for when and/or where to receive respective information. This could include mountainous designations, water locations, state designations, and/or country designations for example.

Proceeding to 270, general settings and overrides can be provided. These settings at 270 allow users to override what they generally use to screen information. For example, during normal work weeks, users may screen out almost all data that may be available to them via the profile 200. When they arrive somewhere on vacation for example and possibly desirous of learning more about a new location or a group, the user may want to simply disable one or more of the controls via the general settings and overrides 270. At 280, miscellaneous controls 280 can be provided. These can include if then constructs or alternative languages for more precisely controlling if and when available data detected for a location is pushed to a user. Other aspects can include trend or usage data that is monitored over time.

The user profile 200 can be updated in several instances and likely via a user interface that is served from a remote server or on a respective mobile device itself. This can include a Graphical User Interface (GUI) to interact with the user or other components such as any type of application that sends, retrieves, processes, and/or manipulates data, receives, displays, formats, and/or communicates data, and/or facilitates operation of the system. For example, such interfaces can also be associated with an engine, server, client, editor tool or web browser although other type applications can be utilized.

The GUI can include a display having one or more display objects (not shown) for manipulating the profile 200 including such aspects as configurable icons, buttons, sliders, input boxes, selection options, menus, tabs and so forth having multiple configurable dimensions, shapes, colors, text, data and sounds to facilitate operations with the profile and/or the device. In addition, the GUI can also include a plurality of other inputs or controls for adjusting, manipulating, and configuring one or more aspects. This can include receiving user commands from a mouse, keyboard, speech input, web site, remote web service and/or other device such as a camera or video input to affect or modify operations of the GUI. For example, in addition to providing drag and drop operations, speech or facial recognition technologies can be employed to control when or how data is presented to the user. The profile 200 can be updated and stored in substantially any format although formats such as XML may be employed to capture user controls and instructions.

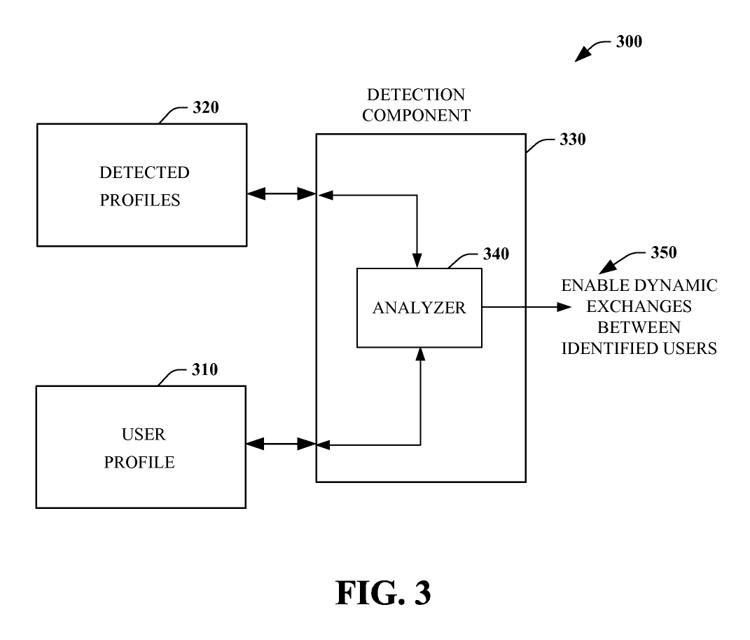

Turning to FIG. 3, a system 300 illustrates profile analysis and matching for determining dynamic groups. In this aspect, a user profile 310 and one or more detected profiles 320 are processed by a detection component 330 to determine dynamic groups for information exchange. As shown an analyzer 340 compares characteristics or parameters of the user profile 310 with characteristics or parameters received from the detected profiles. If suitable group compatibility is detected by the analyzer 340, a dynamic group for information exchange is enabled at 350. Analyzer output at 350 can be signals that are sent to respective user devices among members of an identified group that allow such members to then exchange data. For example, based on setting in the user profile 310, the analyzer 340 may determine that four other detected profiles 320 have been located that are compatible with a given user's profile 310. Based on the determined compatibility by the analyzer 340, enabling signals or codes can be sent to user devices associated with the user profile 310 and the detected profiles 320.

As can be appreciated, the analyzer 340 can employ various criteria to determine compatibility for a group of individuals. This can include profile settings that define how close a particular match is to be before declaring a detected profile 320 as a member of a group. In on case, settings and thresholds can be defined where the setting may indicate that if certain amount or parameters or criteria are met, then the analyzer 340 declare a match for a detected profile 320. With respect to anyone parameter or criteria, thresholds may be applied to such criteria. For example, one criteria may define a rule that says, if any other users are detected that indicate they subscribe to more than three sports clubs, then declare that individual a match. Some settings as noted above with profiles can be generalized i.e., declare all detected profiles in this range to be members of a group or all detected profiles in the next hour to be members of the group and so forth. Various rules, parameters, thresholds, and other criteria can be specified via user interface associated with a device or platform.

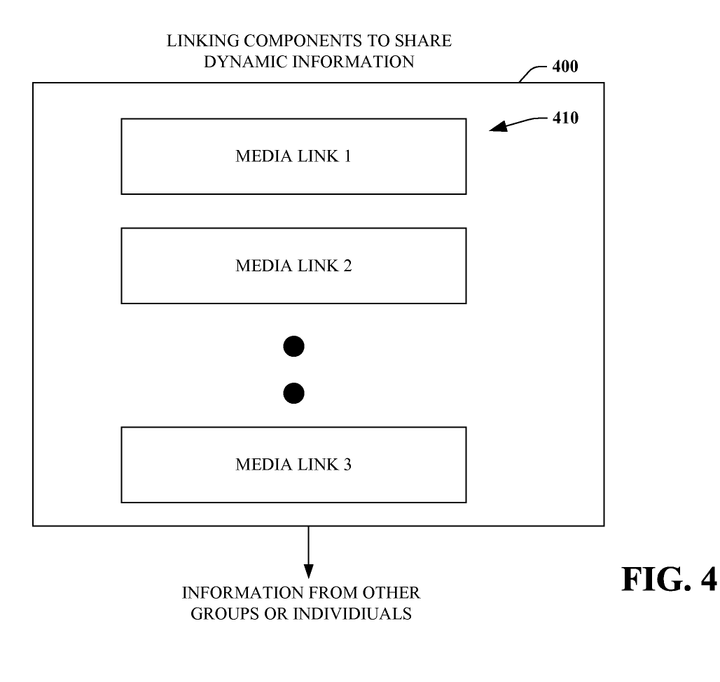

Referring to FIG. 4, media linking components 400 for exchanging dynamic information are illustrated. The media linking components 400 include one or more links 410 for sharing dynamic information between members of a group or from previous members to someone who may be encountering an item for the first time. The links 410 can be generated by other users who may have an impression about a given item such as an album, compact disk, painting, menu, wine list, travel tips, and so forth that may provide other information to a user. The links 410 can be web links, media stream links where an audio, video, or image file (or files) is played for a user. Such links 410 can be generated by other users who may encountered a particular data item or can be provided by the originator of the source. For example, for an art piece, the original artist may have embedded URL links that provide information about the particular piece of art and the artist himself. As other users encounter the artwork, they can record their impressions on their device and upload such impressions to a general data store associated with the artwork. From that collection, links 410 can be automatically created that refer to the other users' comments and impressions.

As noted previously, a discovery process can be linked to varying types of media. For instance, if a person were looking at an album cover, links 410 could be provided relating to similar works of art, underlying artists, the group of knowledge of the particular work when viewing the album, and tangential links 410 that flowed from the original viewing. In addition to album covers, substantially any type of media could be annotated with the links 410 and be adaptively updated over time by users coming in contact with the media. Adaptive profiles can also be maintained where data that users come in contact is continually updated on preferences and context and subsequently shared as appropriate. For example, the links 410 can encode metadata about the people who created the links. If the metadata is related to a profile of a user coming in contact therewith, then the links 410 can be enabled for receiving more information. If the links 410 do not relate to a given user's profile (determined by an analyzer) then the links can be hidden from view or disabled if desired.

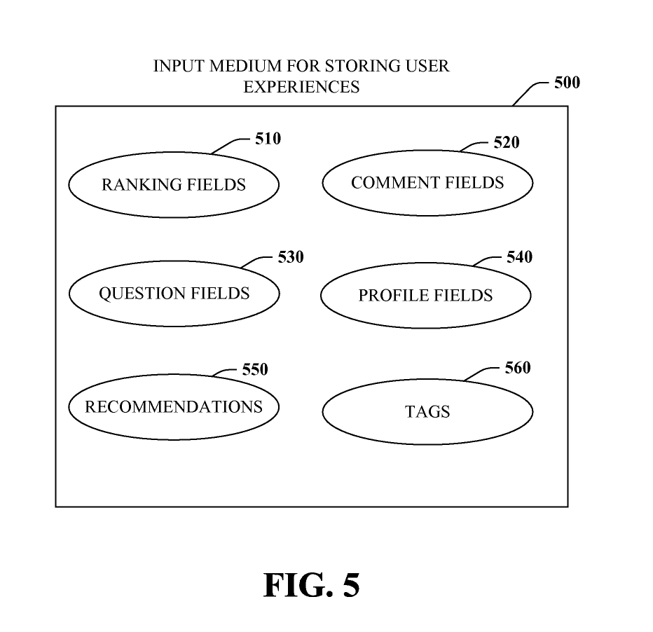

Turning to FIG. 5, input media 500 is illustrated for storing and sharing user experience data. As noted above, individuations can be invited to rank or evaluate a situation, where other people's opinion of the same situation can be exchanged between members of a group. For example, if a DJ were running a particular event, people could be encouraged to contribute an evaluation that could be shared with other members of the group who were also listening. Such dynamic evaluations could be shared over time as well. Such rankings could form the basis for dynamic collections where individuals could potentially generate their own frame by how they appear and are populated on the collections. To support such information exchange, the input media 500 can be interfaced via a device user interface or an interface served locally, or an interface served to the device that can be an XML file or other format. The input media 500 can capture user's impressions that can be stored and experienced by other users. It is noted that such media 500 can be associated with substantially any device or served from remote locations to identified group members.

As shown, the input media 500 includes several inputs for recording user experiences that can be shared with subsequent users. At 510, ranking fields can include survey information provided by the respective users showing there likes or dislikes of a given situation. At 520, comment fields include generalized feedback from users regarding their impressions. This can include textual data, audio data, video data or combinations thereof. Proceeding to 530, question fields can provide data regarding answers to predetermined questions provided about a situation or location. At 540, profile fields can share information regarding the types of users who have provided data. In some cases, this may include personal or identity information if users were so inclined to enter such data. At 550, other recommendations can be provided by users. This may include information that supplements given information generated by members of a group. For example, providing information that indicated that 200 that a special was being offered to senior citizens in a store. At 560, tag information can be provided. Tags may store information that is then tied to information stored on a globally accessible database, thus the tags provide links to the other data locations.

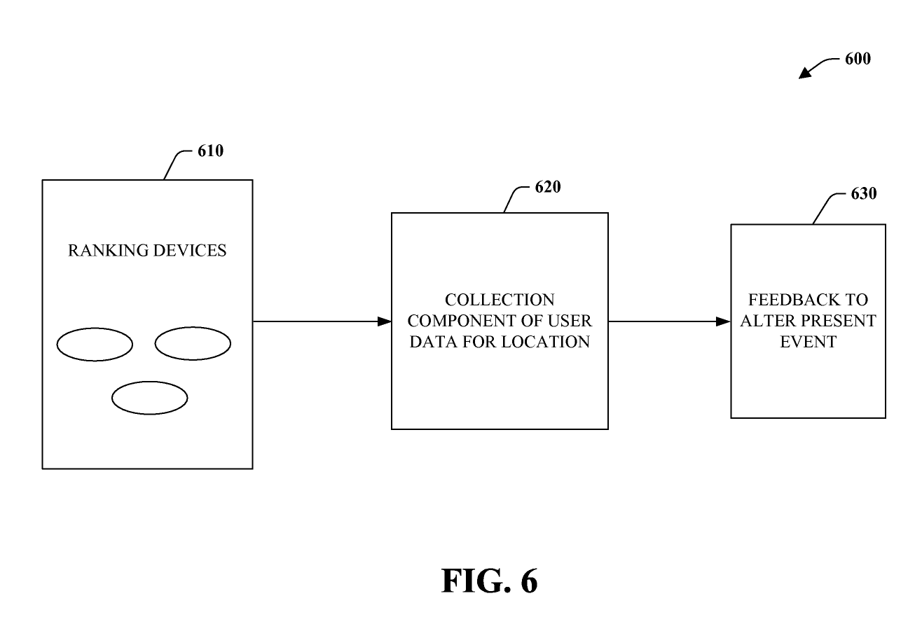

Referring to FIG. 6, a system 600 illustrates user based feedback for dynamically altering event outcomes. The system 600 relates to dynamic situations and locations such as movie theaters, concerts, plays, political events, DJ events, and so forth that can be dynamically altered or adjusted based upon feedback generated by users within vicinity of a given location. Other examples include teammate reviews where people could share thoughts on how a particular user ranked in a certain game or other scenario. For example, a power user may be rated as very difficult to beat where novice users may have some other indication. As time goes by and opinions are gathered, people's standing within a particular game can dynamically change and exchanged between users based off their profiles. Opinions can also be gathered and shared concerning how people actually felt about playing a particular game or witnessing an event, for example. The system 600 includes one or more ranking devices which could be provided at an event or can be electronic interfaces that are received at wireless devices such as cell phones, gaming interfaces, PDA's or music devices, for example. Data generated by the ranking devices 610 can be gathered and analyzed by a collection component 620 where the collective mood of a group from users of similarly situated profiles can be determined.

Based on the determined mood or other criteria at 620, feedback 630 can be presented to the organizers or sponsors of an event where presentations at the event can be changed or altered. For example, a DJ operating a local night club may receive feedback 630 from a plurality of users that disco music is preferred over some other alternative format. Other indications may include letting the DJ know that music is being played too loudly or not loudly enough for example. In a political setting example, candidates at a debate can receive immediate feedback 630 on their responses and alter further responses based on such feedback if desired. As can be appreciated, substantially any type of event that is open to the public can employ audience feedback 630 from the venue to dynamically alter a given presentation. Marketers can also employ feedback 630 to adjust sales offerings to the group if desired. Based on profile information however, some users may not be enabled to receive such solicitations however.

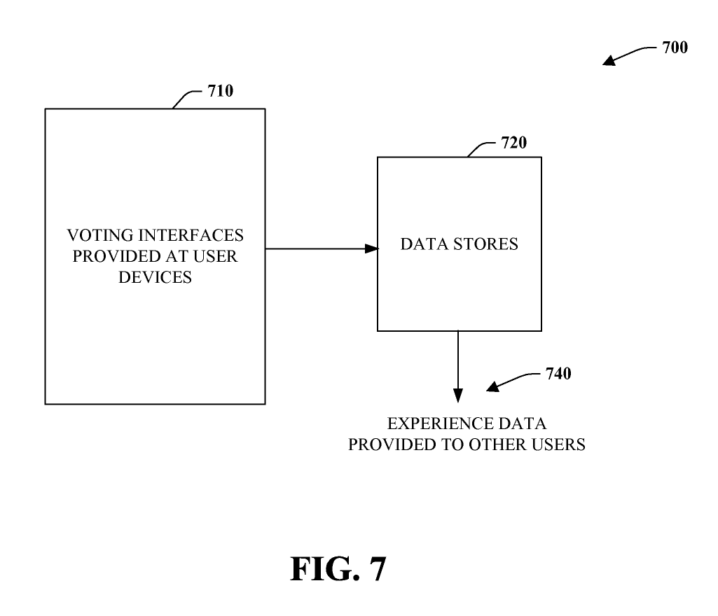

Referring to FIG. 7, a system 700 illustrates voting interfaces 710 that can be generated to enable information exchange between members of dynamic groups. In this example, one or more voting interfaces 710 can be generated at a user's device to enable storing user impressions at a data store 720 and/or to allow one or more users to receive other users' impressions from the data store 720. As noted previously, the voting interfaces 710 can enable voting schemes so that when one comes in contact with a given media, a platform such as a cell phone interface can be provided to presently vote and dynamically view past and present opinions on the selected media, where the opinions are stored and received from the data store 720. The data store 720 can be a local device that is updated as media experiences are provided by respective users or can be a remote device that records experiences over the Internet for example. Shared media experiences can include real time events such as watching a football game while arriving at something one wants to share in the group and passing that along to other media outlets such as to someone's desktop or cell phone. Gaming experiences can be enhanced by providing the interfaces 710 during portions of the game or when new game experiences are encountered. As can be appreciated, the voting interfaces 710 can be associated with substantially any type of media that a user's device may come in contact with.

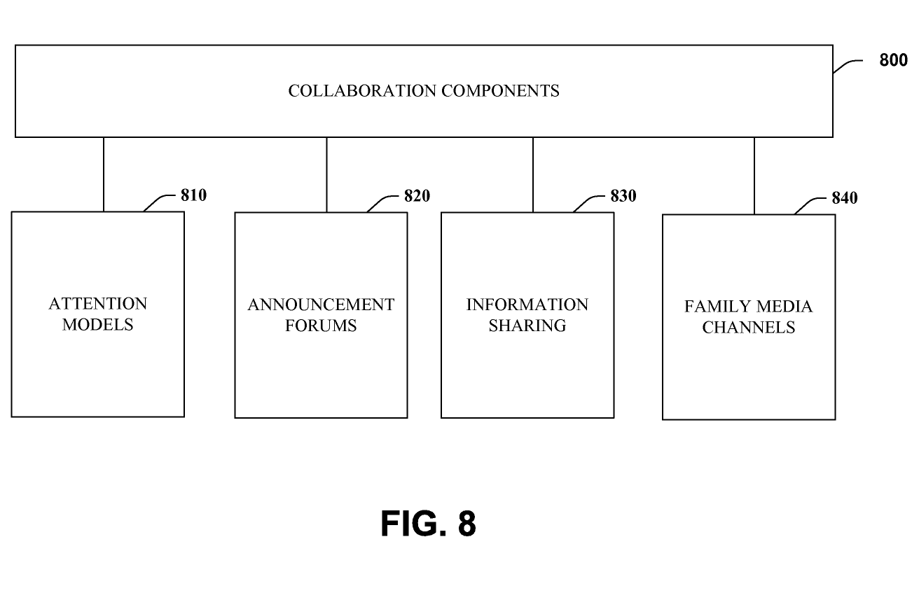

Referring now to FIG. 8, a system 800 illustrates building dynamic networks to share information based on location. One or more player attention models 810 can be provided and dynamically determined from present and past experiences. Such models can be employed to dynamically adjust present user experiences. The models 810 can be learning models that adapt to events and data over time. For example, one model 810 may determine that the user shows little interest in a particular aspect of a game yet spends the majority of their time within the context of another aspect such as another scene or game scenario. The models 810 can be tuned to account for differences in a respective player's attention and interests. Along with player attention models 810, crowds and groups can be modeled from the collective and personal data stores that have been previously described. At 820, public announcement forums can be provided where an employee for example could make an announcement and that would be shared with a group identified by the profiles described above. Announcement forums 820 can be associated with substantially any type of social event or situation.

Collaborative components 800 can include one or more information sharing components 830. The information sharing components 830 can include interfaces that enable such aspects as sharing schedules or collections that can be dynamically collected and distributed across similarly situated users defined by the profiles described above. One or more family media channels 840 can be created based on familial associations and content. This could include creating a short term network to share family vacation pictures or other media, for example. In addition to family media channels that can be exchanged with identified members of a group, other associations can be defined such as work groups, hobby groups, advocacy groups, and so forth.

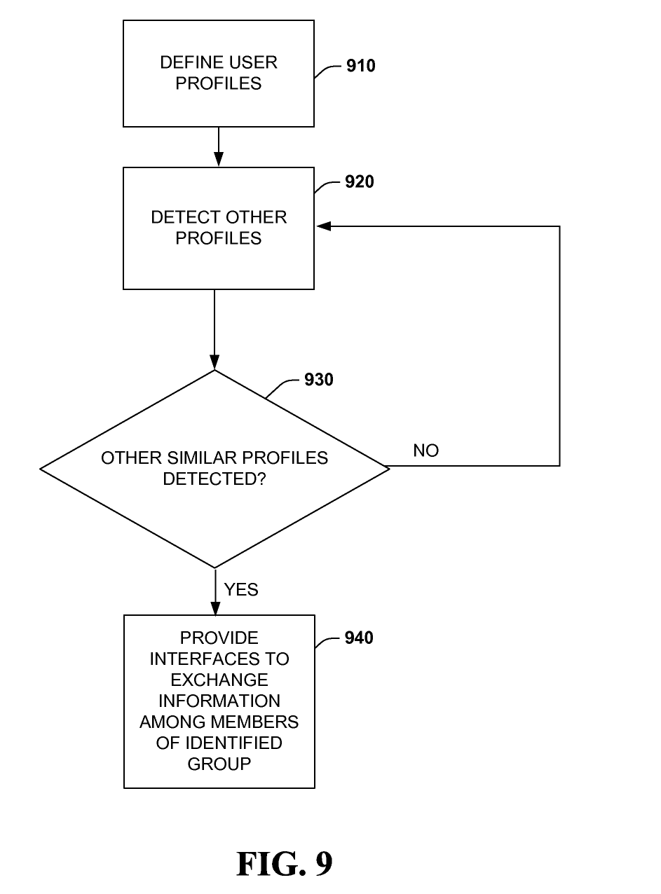

FIG. 9 illustrates an exemplary process 900 for exchanging information between members of an identified group. While, for purposes of simplicity of explanation, the process is shown and described as a series or number of acts, it is to be understood and appreciated that the subject processes are not limited by the order of acts, as some acts may, in accordance with the subject processes, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject processes described herein.

Proceeding to 910, user profiles are defined. The profiles include parameters that describe a user's state, context, and preferences with regard to receiving information from other potential members of a dynamic group. At 920, one or more other profiles are detected. This may include exchanging profiles between users or with a central server in a region or defined area or broadcast capability. At 930, the detected profiles of 920 are analyzed in view of the user profiles 910. This includes comparing profiles to determine if users are compatible with other and whether or not parameters or other criteria within a profile match those of other profiles. The criteria can include parameter thresholds such as if a certain number of parameters are similar, then a profile match id determined. Matches can be determined off of a single parameter or parameter threshold. If no profile match is detected at 930, the process proceeds back to 920 to detect other profiles. If a profile match is detected at 930, the process proceeds to 940 where one or more interfaces are provided to exchange information between members of a dynamically detected group. Such information can include data collections, voting schemes, opinions, rankings or other data that is exchange among members of an identified group.

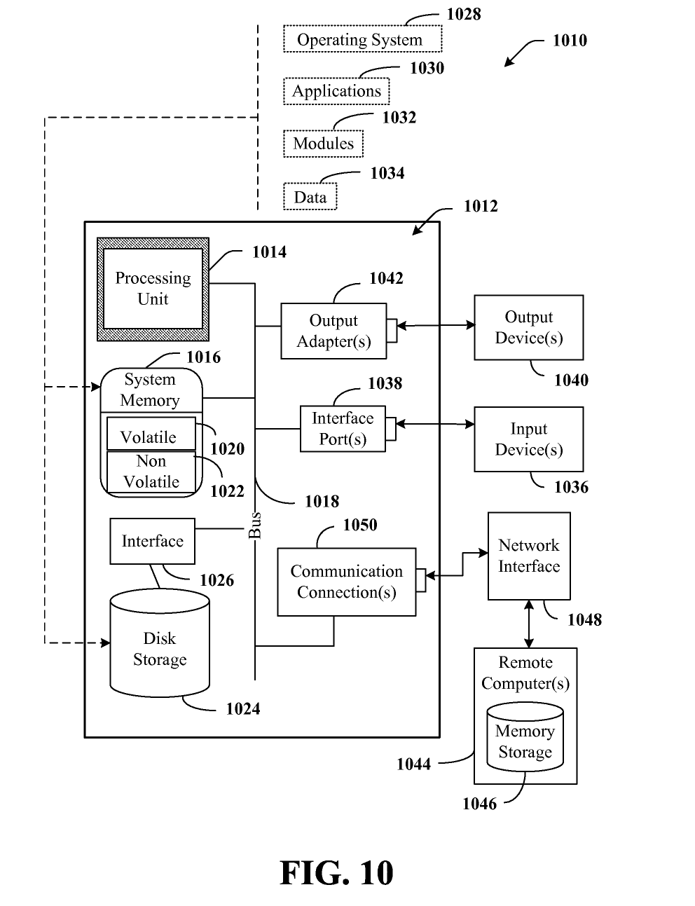

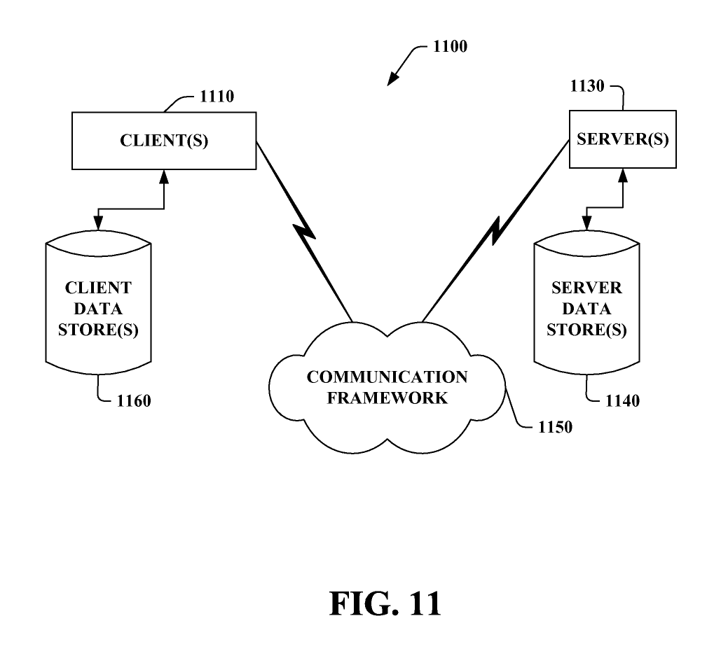

In order to provide a context for the various aspects of the disclosed subject matter, FIGS. 10 and 11 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that performs particular tasks and/or implements particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 10, an exemplary environment 1010 for implementing various aspects described herein includes a computer 1012. The computer 1012 includes a processing unit 1014, a system memory 1016, and a system bus 1018. The system bus 1018 couple system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 10-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that various components described herein can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012 and to output information from computer 1012 to an output device 1040. Output adapter 1042 is provided to illustrate that there are some output devices 1040 like monitors, speakers, and printers, among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

FIG. 11 is a schematic block diagram of a sample-computing environment 1100 that can be employed. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing the components described herein, for example. One possible communication between a client 1110 and a server 1130 may be in the form of a data packet adapted to be transmitted between two or more computer processes. The system 1100 includes a communication framework 1150 that can be employed to facilitate communications between the client(s) 1110 and the server(s) 1130. The client(s) 1110 are operably connected to one or more client data store(s) 1160 that can be employed to store information local to the client(s) 1110. Similarly, the server(s) 1130 are operably connected to one or more server data store(s) 1140 that can be employed to store information local to the servers 1130.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for sharing collective information, comprising:
a profile component that receives information regarding a user's profile;
a detection component to determine profiles of other users related to the user's profile; and
a content component to relay data associated with the other users in view of the user's profile.

2. The system of claim 1, the profile component captures a state and preferences associated with the user.

3. The system of claim 2, the profile component includes interruption component, a recreational component, an artistic component, a security component, a time component, a calendar component, a geographical component, a trend component, or a general settings component.

4. The system of claim 1, the detection component includes an analyzer to compare profiles between a user and one or more other users and in order to further determine members of a group.

5. The system of claim 1, further comprising one or more links components to facilitate exchange of information form a data item to one or more users.

6. The system of claim 5, the links components are associated with a web address, an audio file, a video file, or a text file.

7. The system of claim 1, the links components are updated by one or more users that encounter the links components.

8. The system of claim 1, further comprising an interface to facilitate inviting users to rank or evaluate a situation and provide other user's opinion of the situation.

9. The system of claim 8, the situation is associated with a live event or a game.

10. The system of claim 1, further comprising an interface to share data collections among members where the collections include at least one ranking of at least one member.

11. The system of claim 1, further comprising an adaptive profile where data that users come in contact is automatically updated regarding associated preferences and context.

12. The system of claim 1, further comprising one or more player attention models that are dynamically determined from present and past experiences and employed to dynamically adjust present user experiences.

13. The system of claim 1, further comprising an interface to provide a public announcement forum where a user can make an announcement that is shared with a group identified by a profile.

14. The system of claim 1, further comprising one or more group models that are trained from collective and personal data stores.

15. The system of claim 1, further comprising one or more group media channels that are based in part on group associations and content.

16. The system of claim 15, the group media channels are associated with a family association.

17. A method to facilitate dynamic data exchanges between users, comprising:
analyzing a user or a group profile;
detecting at least one other profile in addition to the user or group profile; and
comparing the user or the group file profile to the other profile to determine a dynamic relationship between users or groups.

18. The method of claim 17, further comprising generating at least one interface to facilitate communications between the users.

19. The method of claim 18, further comprising generating at least one data collection to share information between the users.

20. A user based information system to exchange data, comprising:
means for identifying a user's preferences and state; and
means for analyzing the profile in view of other detected profiles to facilitate dynamic data exchange between users.
